(19) United States
(12) Patent Application Publication
(10) Pub. No.: US 2004/0173518 A1
(43) Pub. Date: Sep. 9, 2004

(54) Coaxial filter and pump

(76) Inventor: Kuang Cheung Yuan, Longjiang (CN)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/378,561

(22) Filed: Mar. 3, 2003

(51) Int. Cl. B01D 35/26

(52) U.S. Cl. 210/416.3; 210/435

(57) ABSTRACT

Disclosed herein is a water filtration and pumping apparatus. In one embodiment, the apparatus may include a casing having a central axis, an inlet and an outlet, an electric motor located in the casing and having an output shaft along the axis, an impeller driven by the output shaft to rotate about the axis to pump water from the inlet to the outlet, and an annular filter element through which the water is pumped, the filter element also surrounding the axis.

### BACKGROUND

Swimming pool water filtration and pumping assemblies are commonly large and heavy. The pump and filter are generally housed in separate units connected by PVC piping. A licensed plumber or pool expert is generally required to configure the pump and filter and put them into operation. In addition, swimming pool filter elements are commonly complex and flimsy in construction, requiring special effort in cleaning and maintenance. The flimsy nature of filter elements also renders them susceptible to damage, should water-flow from the pump impinge upon them directly.

### SUMMARY

Disclosed herein are unitary water filtration and pumping assemblies having no external plumbing between the pump and filter. In addition, disclosed herein is a compact unitary water filter and pump assembly comprising a single housing within which there is an electric motor, a filter element and an impeller all in axial alignment.

In one exemplary embodiment, a water filtration and pumping apparatus may comprise a casing having a water inlet and a water outlet, wherein the casing houses a replaceable filter cartridge, an impeller, and a motor, and wherein the motor drives the impeller, and the impeller pumps water from the water inlet to the water outlet through the replaceable filter cartridge.

In another exemplary embodiment, a water filtration and pumping apparatus may comprise a casing having an inlet and an outlet, a motor located in the casing and having an output shaft, an impeller driven by the output shaft to rotate about a central axis to pump water from the inlet to the outlet, and a filter element through which the water is pumped.

In another exemplary embodiment, the central axis may be vertical.

In another exemplary embodiment, the casing may further comprise a substantially cylindrical portion and a substantially frustoconical portion.

In another exemplary embodiment, the filter element may be a replaceable filter cartridge.

In another exemplary embodiment, the filter may be located above the motor and the impeller.

### BRIEF DESCRIPTION OF THE DRAWINGS

These and other features and advantages of the water filter and pump assemblies disclosed herein will be more fully understood by reference to the following detailed description, in conjunction with the attached drawings in which like reference numerals refer to like elements through the different views. The drawings illustrate principles of the apparatus disclosed herein, and are not to scale.

FIG. 1 is a schematic elevation of a water filter and pump assembly, and

FIG. 2 is a schematic cross-sectional elevational view of the assembly taken at II-II in FIG. 1.

### DETAILED DESCRIPTION OF EXEMPLARY EMBODIMENTS

To provide an overall understanding, certain illustrative embodiments will now be described; however, it will be understood by one of ordinary skill in the art that the devices and methods described herein can be adapted and modified to provide devices and methods for other suitable applications and that other additions and modifications can be made without departing from the scope of the systems described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, specified, interchanged, and/or rearranged without departing from the disclosed devices or methods. Additionally, the shapes and sizes of components are also exemplary, and unless otherwise specified, can be altered without affecting the disclosed devices or methods.

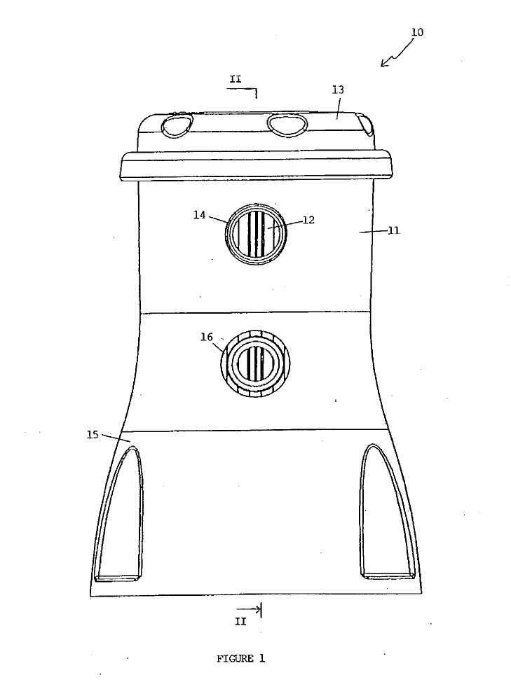

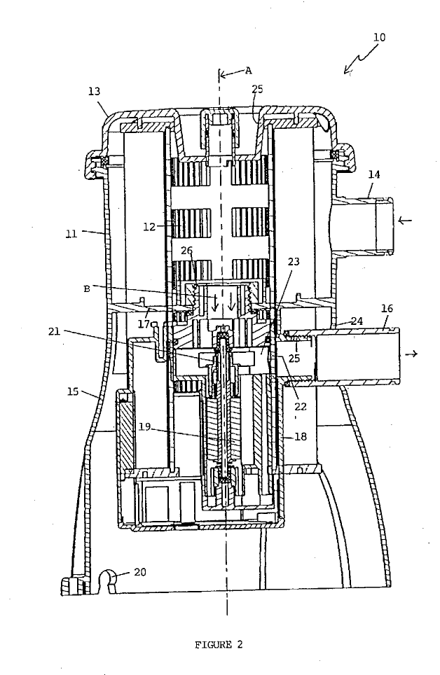

In the accompanying FIGS. 1 and 2 there is schematically depicted a filter and pump casing 10. Casing 10 is typically made from molded plastic material such as PVC. However, any other suitable plastic, metal, or composite material might be used.

The case 10 may have an upper cylindrical portion 11 housing a filter element (not shown) located within a perforated filter housing 12. The cylindrical portion 11 has attached to its upper end a lid 13. In the illustrated embodiment, the lid 13 is affixed to the casing 10 by means of a threaded interengagement. Other suitable means for affixing the lid may be employed, including snap fitting, a flange assembly using bolts or screws, or other similar closure. In an exemplary embodiment, the lid 13 has a central indentation 25 that presses upon and therefore seals against the filter element located within the housing 12. The upper cylindrical portion 11 has a water inlet 14 which may be formed integrally therewith.

In the illustrated embodiment, when viewed from above, the casing 13 is circular and comprises a central vertical axis A. Other cross sectional shapes may be employed.

In the embodiment illustrated in FIGS. 1 and 2, a lower frustoconical portion 15 houses a motor 19, and also serves as a base, extending downwardly from the upper cylindrical portion 11 of the casing. The lower portion 15 may be formed integrally with the upper portion 11. The water outlet 16 may be located at the transition area between the upper cylindrical portion 11 and the base portion 15. It will be understood that the precise shape of the casing is not crucial to the operation of the apparatus.

In the illustrated embodiment, the water inlet 14 and the water outlet 16 are parallel and extend normally from the vertical axis A. The outlet 16 passes through an aperture 24 in the casing 10, without necessarily touching the casing. The outlet 16 may have a threaded end that is threaded upon an extension 25 of a pump housing 18 located within the casing 10.

Inside the casing 10, there is a partition 17 dividing the interior into two separate portions. The upper portion houses the filter. The filter cartridge to be received within the filter housing 12 may be a replaceable paper cartridge of annular form having a hollow center surrounded by a perforated metallic cylinder that is in turn surrounded by fluted filter paper. Alternatively, other suitable water filter elements may be employed. In the illustrated embodiment, the filter element is approximately centered on the axis A and comprises upper and lower resilient plastic or rubber seals, the upper one of which bears against the indentation 25, and the bottom one of which bears against the floor 26 of the housing 12.

Depending from the partition 17 is an electric motor casing 18 within which there is located a motor 19. In an exemplary embodiment, the motor 19 is a compact, high-output electric motor. The motor 19 may receive electric power via a cord (not shown) which can pass into the casing via a cord cut-out 20.

The electric motor 19 has an output shaft 21 that may be co-linear with the axis A. Attached to the shaft 21 within a sealed pump housing 22 is an impeller 23. Impeller 23 is driven by the shaft 21 to rotate about axis A.

The motor housing 18 is screwed to the partition 17, or otherwise affixed within the lower portion 15 of the casing 10 so as to be removable therefrom for servicing or replacement.

The impeller 23 draws water from the middle of the filter cartridge downwardly as indicated by arrows B in FIG. 2 and expels the water via outlet 16.

The configuration described herein, in which the impeller, motor, and filter are all contained within a single compact housing, provides a unitary water filtration and pumping apparatus having no external plumbing between the pump and filter.

In use, PVC or other piping, either rigid or flexible, is attached to the inlet 14 and outlet 16 to draw and return locations of a swimming pool. Upon activation of the motor 19, the shaft 21 rotates the impeller 23 to create suction within the filter housing 12 to thereby draw water in via inlet 14, through the filter element, downwardly as indicated by arrows B and then out via outlet 16 for return to the swimming pool.

It should be appreciated that modifications and alterations obvious to those skills in the art are not to be considered as beyond the scope of the present invention. For example, of the coaxial alignment of the motor, impeller and filter need not be vertical. That is, a horizontal arrangement is considered to be within the scope of the invention.

Furthermore, the invention can be used with spa pools, spa baths, or other applications requiring water-filtration.

What is claimed is:

1. A water filtration and pumping apparatus comprising:
a casing having an inlet and an outlet;
a motor located in the casing and having an output shaft;
an impeller driven by the output shaft to rotate about a central axis to pump water from the inlet to the outlet; and
a filter element through which the water is pumped.

2. The apparatus of claim 1, wherein the central axis is vertical.

3. The apparatus of claim 1 wherein the casing further comprises a substantially cylindrical portion and a substantially frustoconical portion.

4. The apparatus of claim 1 wherein the filter element is a replaceable filter cartridge.

5. The apparatus of claim 1 wherein the filter is located above the motor and the impeller.

6. The apparatus of claim 1 wherein the water inlet extends substantially normal to said axis.

7. The apparatus of claim 1 wherein the water outlet extends substantially normal to said axis.

8. The apparatus of claim 1 wherein the water inlet and water outlet are parallel.

9. The apparatus of claim 1 wherein the casing has an open bottom within which the motor depends.

10. A water filtration and pumping apparatus comprising a casing having a water inlet and a water outlet, wherein the casing houses a replaceable filter cartridge, an impeller, and a motor, and wherein the motor drives the impeller, and the impeller pumps water from the water inlet to the water outlet through the replaceable filter cartridge.
